(19) United States
(12) Patent Application Publication
(10) Pub. No.: US 2026/0246895 A1
(43) Pub. Date: Aug. 20, 2026

(54) MAINTAINING AUDIO QUALITY DURING PERIODS OF MISSING DATA FOR MULTI-MICROPHONE SYSTEMS

(71) Applicant: Zoom Communications, Inc., San Jose, CA (US)

(72) Inventors: Yifeng Fan, Foster City, CA (US); Qiang Gao, Pineville, CA (US); Zhaofeng Jia, Saratoga, CA (US); Gang Shi, San Jose, CA (US); Xinyu Yao, Hefei (CN); Xiangmin Zhu, Hefei (CN)

(73) Assignee: Zoom Communications, Inc., San Jose, CA (US)

(21) Appl. No.: 19/537,132

(22) Filed: Feb. 11, 2026

(30) Foreign Application Priority Data
Feb. 14, 2025 (CN) 202510172524.7

(51) Int. Cl. H04N 7/15

(52) U.S. Cl. CPC H04N 7/15

(57) ABSTRACT

Techniques for maintaining audio quality during periods of missing data for multi-microphone systems are disclosed. In an example method, a computing system receives multiple audio streams from multiple audio capture devices, each audio stream populating a buffer of multiple buffers including a first buffer, a second buffer, and a reference buffer. The method further involves determining that a first quantity of audio data in the reference buffer exceeds a first predetermined threshold. The method further involves determining that a second quantity of audio data in the first buffer is below a second predetermined threshold. The method further involves applying an audio reconstruction technique to the first buffer to generate additional audio data to add to the first buffer. The method further involves generating an audio output stream using the reference buffer, the first buffer, and the second buffer.

### CROSS-REFERENCE TO RELATED APPLICATION

This application claims priority to Chinese national application No. 202510172524.7 entitled “Maintaining Audio Quality During Periods of Missing Data for Multi-microphone Systems” and filed on Feb. 14, 2025, the entire disclosure of which is incorporated herein by reference for any purpose.

### FIELD

The present application generally relates to audio engineering, and more particularly relates to techniques for maintaining audio quality during periods of missing data for multi-microphone systems.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to some aspects of the present disclosure.

FIG. 2 shows an example system in which a video conference provider provides videoconferencing functionality to various client devices, according to some aspects of the present disclosure.

FIG. 3 shows an example user interface that may be used in some example systems configured for techniques for maintaining audio quality during periods of missing data for multi-microphone systems, according to some aspects of the present disclosure.

FIG. 4 shows an example of a system implementing methods for maintaining audio quality during periods of missing data for multi-microphone systems, according to some aspects of the present disclosure.

FIG. 5 shows an example of audio buffers that may be used for maintaining audio quality during periods of missing data for multi-microphone systems, according to some aspects of the present disclosure.

FIG. 6 shows a flowchart of an example method for maintaining audio quality during periods of missing data for multi-microphone systems, according to some aspects of the present disclosure.

FIG. 7 shows another flowchart of an example method for maintaining audio quality during periods of missing data for multi-microphone systems, according to some aspects of the present disclosure.

FIG. 8 shows an example computing device suitable for use in example systems or methods for maintaining audio quality during periods of missing data for multi-microphone systems, according to some examples of the present disclosure.

### DETAILED DESCRIPTION

Examples are described herein in the context of techniques for maintaining audio quality during periods of missing data for multi-microphone systems. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Video conferencing is an indispensable and integral part of modern living, in both enterprise and personal contexts. While a basic use case involving disparate participants each at a remote location is common, hybrid video conferencing, in which some participants are physically together, in-office while some others are remote, is increasingly common. For example, some participants may join a video conference, together, in conference room, while some other participants join the video conference from personal client devices at remote locations.

Integrated video conferencing systems such as the “Zoom Room” produced by Zoom Communications, Inc. provide a seamless platform for high-definition video meetings by integrating software and hardware for both audio and video. Such integrated video conferencing systems are designed to meet the needs of hybrid work environments and may be situated in conference rooms or other public meeting places. Integrated video conferencing systems have a diverse spectrum of use cases and are suitable for diverse locations such as offices, classrooms, or homes. Integrated video conferencing systems can allow participants to join video conferences either on-site or remotely. For example, in a typical integrated video conferencing system session, some individuals may gather in a conference room equipped with an integrated video conferencing system, while others connect virtually using a client device executing video conference client software.

Audio plays a vital role in ensuring effective communication and collaboration when using integrated video conferencing systems. For example, an integrated video conferencing system may feature built-in microphones, positioned either near the video output device (e.g., television or monitor) or on a nearby table, to capture audio from participants in the conference room. However, maintaining high-quality audio can be challenging in certain scenarios, such as when speakers are positioned far from the microphones. This can lead to degraded audio quality due to factors such as reverberation, signal scattering, or decay during transmission.

To tackle this challenge, some existing integrated video conferencing systems can enable participants to use their personal devices, such as laptops and smartphones, as audio capture devices, along with microphones connected to the integrated video conference system. Consequently, the hardware and software executing on such devices can implement certain sound engineering technologies (e.g., acoustic echo cancellation, noise suppression, automatic gain control, etc.) to enhance audio quality. This approach enables a dynamic multi-microphone system where the built-in microphones of the integrated video conferencing system work in tandem with the microphones of users' devices. Such multi-microphone configurations can utilize multiple microphones to capture audio input.

More generally, multi-microphone setups, according to this disclosure, may be used in a variety of contexts. In various examples, multiple microphones can be integrated into a single device, distributed across multiple devices, or combinations thereof. The various microphones in a multi-microphone configuration can be configured to operate collaboratively to enhance audio quality, extend coverage areas, process directional audio, or provide spatial information. Such configurations are widely used in various applications, including video conferencing, smart devices, and music or film production and may be referred to as distributed multi-microphone systems.

One difficulty faced by designers and operators of distributed multi-microphone systems relates to how the system responds to audio data lost due to network errors, network congestion, or other causes that prevent all of the audio input data being streamed from a given audio capture device to a remote network location. For example, in a distributed multi-microphone system, analog audio may be captured by each respective audio capture device and converted to a digital form using an analog-to-digital conversion (“ADC”) process. The digitized audio can be partitioned and encapsulated into a number of audio “packets” (e.g., TCP/IP or, UDP/IP packets, and/or other encapsulated protocols therein such as HTTP) that can be transmitted to a central location via a network or other means to generate an audio output. However, during transmission, network conditions such as traffic congestion, network jitter, buffer overflows at routers, signal degradation in WiFi or wired networks, or other causes can cause packet delays or losses.

Existing approaches for coping with packet loss use technologies such as “packet loss concealment” (“PLC”) to address lost or dropped data packets in audio streams. PLC can compensate for missing data through various methods, including waveform interpolation, time-scale adjustments, or AI-driven predictions such as machine learning approaches. However, PLC is only effective for minor packet losses and is ineffective during periods of prolonged data loss. For example, some PLC implementations can effectively interpolate several tens of milliseconds of missing audio data before degradation of the audio output quality becomes evident to a listener. However, given 1000 milliseconds of missing audio data, use of a similar PLC interpolation technique may result in a considerable subjective loss of audio quality. Existing distributed multi-microphone systems, when generating a final audio output, combine audio buffers from various audio input sources that include missing data or low-quality data generated using PLC, resulting in a significant degradation of audio output quality.

To address these difficulties, a user may employ the systems and methods for maintaining audio quality during periods of missing data for multi-microphone systems, according to this disclosure. In an illustrative example method, a computing system such as an audio output generation subsystem of an integrated video conference system can implement techniques to address both short-term and long-term audio packet loss, as well as network jitter, in distributed multi-microphone systems that aggregate audio data from multiple devices.

In the example method, the computing system receives audio streams from various audio capture devices, such as microphones connected to the integrated video conferencing system as well as user devices being used as additional microphones as described above. In this example, the user devices may be connected to the integrated video conferencing system. The various audio capture devices may be participating in a video conference with one or more remote client devices that are receiving a generated audio output stream derived from the captured audio streams.

The audio frames constituting each audio stream populate an audio buffer such as a queue, array, or other data structure as they arrive. The integrated video conferencing system may include a primary microphone that is physically connected and whose audio frames do not traverse a network prior to generation of the audio output stream.

The audio stream of the primary microphone can populate a reference buffer which can be used to generate the output audio stream without contributions from the other buffers. As a result, the computing system determines that the reference buffer contains sufficient data and is relatively constant before including contributions from the other buffers. Once the reference buffer contains more data than a predetermined threshold amount of data (e.g., 80% full), the computing system can select other buffers to mix with the reference buffer to improve audio quality. For example, the computing system may identify a first buffer and a second buffer as buffers corresponding to a measure of the highest quality audio and combine them with the reference buffer using suitable mixing and smoothing techniques to generate the output audio stream.

Later, the computing system can determine that a quantity of audio data in the first buffer is below a second predetermined threshold. For example, the first buffer may fall below 30% full due to packet loss or significant delay. The computing system can apply an audio reconstruction technique such as PLC to the first buffer to generate additional audio data to add to the first buffer. In cases of severe or sustained packet loss, when the audio reconstruction technique is applied with a frequency exceeding a threshold amount (e.g., 50% of audio frames generating using PLC during a period of time) the computing system can select an alternative microphone according to various criteria that remains unaffected or less significantly affected by network issues prior to combination of the audio input sources, thereby ensuring continuous and high-quality audio delivery. The audio stream that is overly affected by network issues or other delays can be excluded from use for generating the output audio stream.

It should be appreciated that while some examples of the present disclosure are given in the context of integrated video conferencing systems, the techniques disclosed herein are equally applicable to other distributed multi-microphone systems having, for example, a similar data flow and streaming infrastructure. Additional example applications include wearable microphone systems (e.g., hearing aid and assistive listening devices), broadcast or recording setups, surround sound home theater systems, automotive hands-free communication setups, or spatial audio capture systems for augmented reality (“AR”) or virtual reality (“VR”) applications.

Systems and methods according to the present disclosure provide significant improvements in the technical field of audio engineering. The techniques can be used to mitigate audio packet loss, network jitter, and other causes of data loss in distributed multi-microphone systems, that improve over the existing approaches which rely on PLC and which cannot maintain audio quality beyond a relatively small amount of data loss (e.g., 10 milliseconds of audio data). The techniques incorporate continuous monitoring of audio input buffers that apply PLC where it is effective but select audio data from alternative audio input sources when a degree of packet loss exceeds a predetermined threshold prior to combining audio input sources to generate an audio output signal, thus maintaining high-quality audio using a combination of techniques. Moreover, consumption of computational resources is reduced through a reduction in needless application of PLC where it is ineffective as well as through selectively combining audio buffers with sufficiently high quality audio.

These illustrative examples are given to introduce the reader to the general subject matter discussed herein and the disclosure is not limited to these examples. The following sections describe various additional non-limiting examples of systems and methods for maintaining audio quality during periods of missing data for multi-microphone systems.

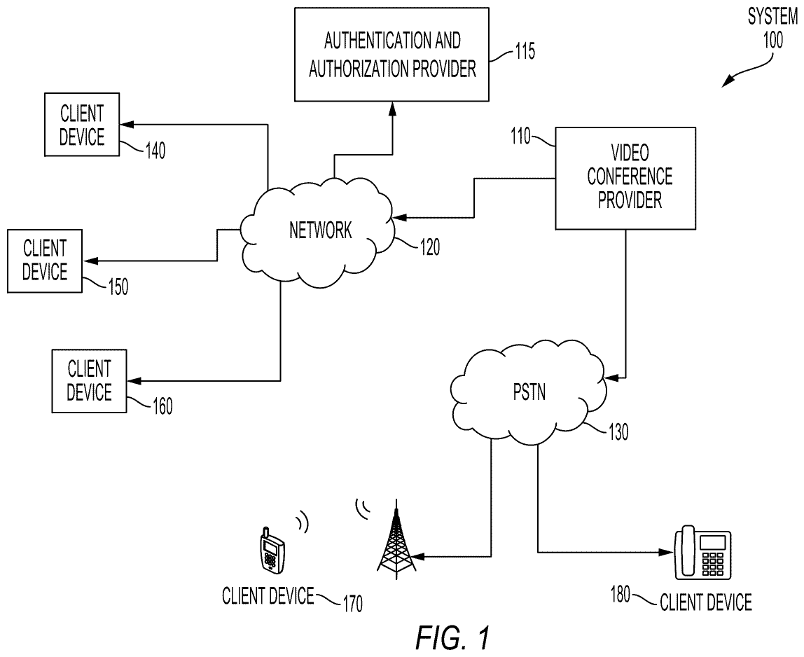

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

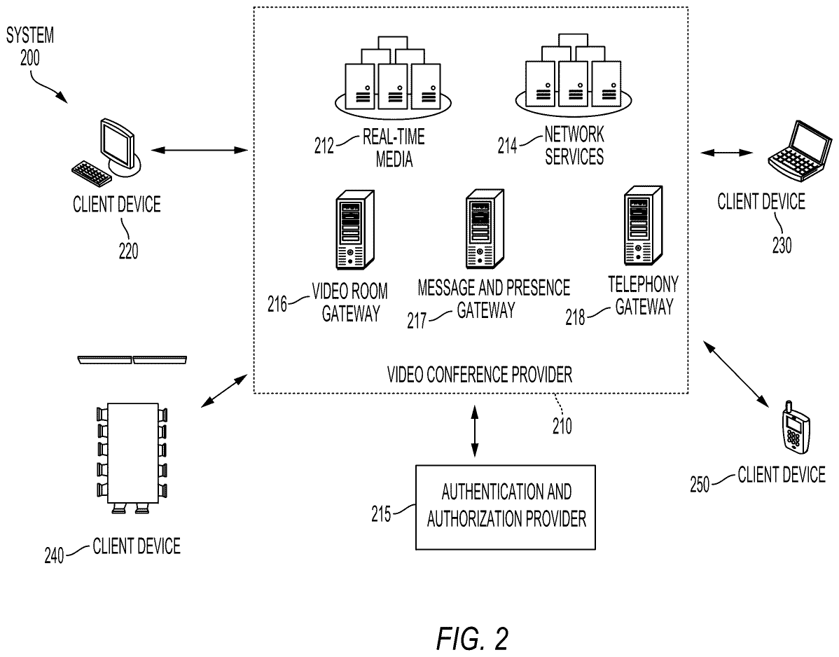

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones, and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

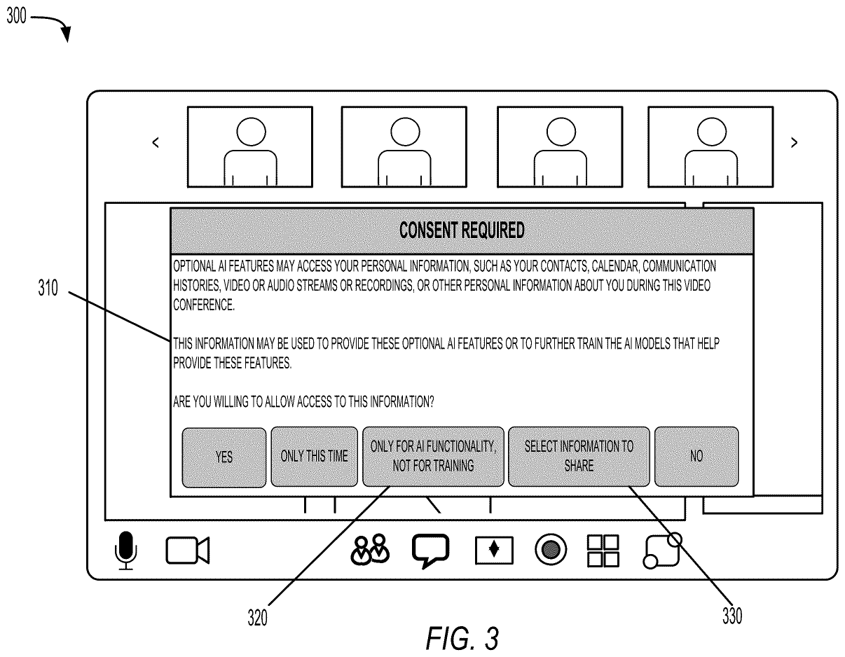

Turning next to FIG. 3, FIG. 3 shows an example user interface 300 that may be used in some example systems configured for maintaining audio quality during periods of missing data for multi-microphone systems, according to some aspects of the present disclosure. In some examples according to the present disclosure, a user may select an option to use one or more optional AI features available from the virtual conference provider. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to provide training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 3, a user has engaged in a video conference and has selected an option to use an available optional AI feature. In response, the GUI has displayed a consent authorization window 310 for the user to interact with. The consent authorization window 310 informs the user that their request may involve the optional AI feature accessing multiple different types of information, which may be personal to the user. The user can then decide whether to grant permission or not to the optional AI feature generally, or only in a limited capacity. For example, the user may select an option 320 to only allow the AI functionality to use the personal information to provide the AI functionality, but not for training of the underlying AI models. In addition, the user is presented with the option 330 to select which types of information may be shared and for what purpose, such as to provide the AI functionality or to allow use for training underlying AI models.

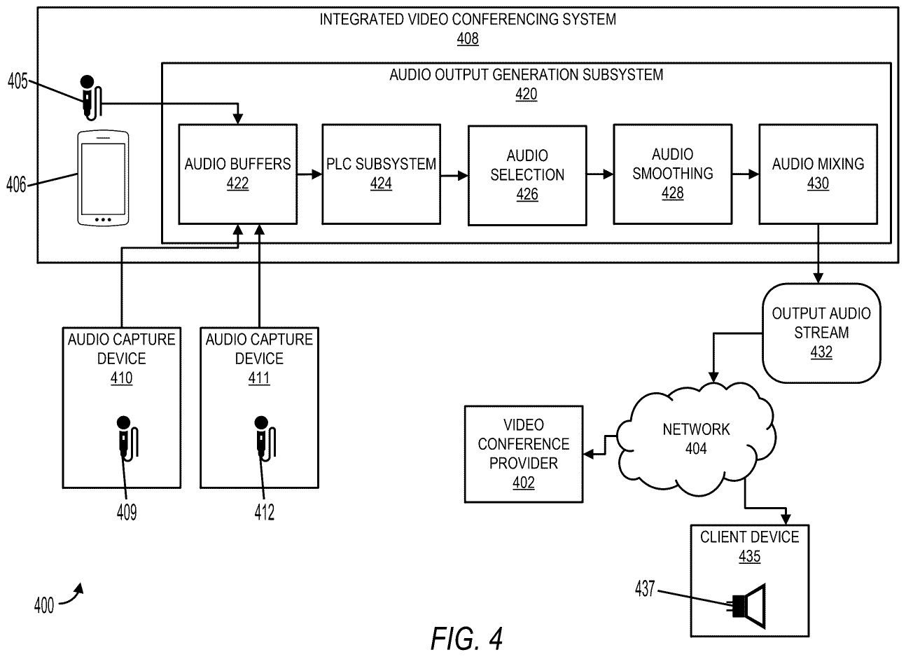

Referring now to FIG. 4, FIG. 4 shows an example of a system 400 implementing methods for maintaining audio quality during periods of missing data for multi-microphone systems, according to some aspects of the present disclosure. System 400 includes a client device 435 and integrated video conferencing system 408 communicatively coupled with video conference provider 402 over a network 404. The client device 435 may be a remote client device engaged in a video conference with a number of participants using the integrated video conferencing system 408. Network 404 may include the Internet, public networks, private networks, or combinations thereof. Video conference provider 402 is typically a server or collection of servers, including a combination of privately or cloud-hosted devices. Video conference provider 402 may be similar, in some respects, to the video conference providers 110, 210 described above with respect to FIGS. 1 and 2.

The integrated video conferencing system 408, such as the “Zoom Room” produced by Zoom Communications, Inc., can provide a dedicated environment equipped for multi-participant video conferencing in one location such as a conference room with a shared camera or cameras capturing video conference participants. The integrated video conferencing system 408 may include a combination of hardware and software components. The integrated video conferencing system hardware may include devices for executing an integrated video conferencing system client application, a controller application, or other software or firmware for implementing integrated video conferencing system 408 functionality such as a laptop, desktop, dedicated hardware device, and so on. The integrated video conferencing system hardware may be configured to install and execute the integrated video conferencing system client application.

High-level video conferencing functionality can be provided by the integrated video conferencing system client application such as hosting video conferences or joining existing video conferences. The controller application can provide additional video conferencing user-facing functionality such as starting or ending video conferences, muting or unmuting microphones, and providing user interfaces for video conference configurations and settings.

For example, the controller application can provide interfaces or graphical user interfaces (“GUIs”) for setting up video conferences, starting and stopping video conferences, microphone controls (e.g., controls for muting or unmuting microphones), camera controls, and so on, represented in FIG. 4 as user interface 406. User interface 406 may be any smartphone, tablet, laptop, etc. suitable for operating the integrated video conferencing system 408 and conducting video conferences using the connected input and output devices, as well as the peripheral client devices in use as microphones, such as audio capture devices 410, 411.

Audio capture devices 410, 411 are communicatively coupled with the integrated video conferencing system 408. For example, the client devices 410, 411 may be used as external microphones for the integrated video conferencing system 408 during a video conference as described above, through embedded microphones 409, 412. The audio capture device 410 and the integrated video conferencing system 408 may exchange data or other information via a remote network such as the Internet or over a local area network such as a LAN, WiFi, mesh, or other suitable network.

The audio capture devices 410, 411 and client device 435 may be any type of device capable of executing the appropriate client software for maintaining audio quality during periods of missing data for multi-microphone systems. For example, the devices 410, 411, 435 may be laptops, desktops, smartphones, tablets, internet protocol (IP) phones, and so on. The audio capture devices 410, 411 includes microphones 409, 412, respectively, which may be internal or embedded microphones (e.g., smartphone microphone) or an external microphone connected via a wired or wireless connection such as Bluetooth.

The integrated video conferencing system 408 includes microphone 405, one of which may be designated as a primary microphone, corresponding to a reference buffer as described below. The microphone 405 may be alternatively referred to as a pivot or reference microphone. The microphone 405 can be a configurable microphone selection which is used as the reference to which all or a subset of the other audio inputs are combined with to generate the output audio stream 432. The selection of the primary microphone may be made in accordance with the particular configuration of the audio input and output application or context. For example, if there is no significant physical, spatial, or electronic differences between the available microphones, any can be chosen as the primary microphone (e.g., one can be chosen randomly). However, in some cases, it may be preferred to select the primary microphone as one whose digital output does not need to traverse a network to avoid compounding error due to network jitter or low latency. Consequently, the primary microphone of the integrated video conferencing system 408 can be a reliable reference for alignment.

The system 400 includes an audio output generation subsystem 420 including components for maintaining audio quality during periods of missing data for multi-microphone systems. The components of the audio output generation subsystem 420 can be implemented in hardware, software, or a combination of both. While the audio output generation subsystem 420 is shown as component of the integrated video conferencing system 408, in other examples the audio output generation subsystem 420 can be a standalone component communicatively coupled over network 404, a component of the video conference provider 402, or an application executed by the audio capture device 410, such as the video conference client application. For example, some or all components of the audio output generation subsystem 420 can be hosted by the video conference provider 402 or the audio capture devices 410, 411. For instance, the audio capture devices 410, 411 can buffer audio locally, apply PLC locally, and then transmit the interpolated audio to the audio output generation subsystem 420 hosted by the integrated video conferencing system 408. In another example, the application of PLC could be performed at a remote server such as the video conference provider 402.

The audio output generation subsystem 420 includes audio buffers 422. The audio buffers 422 receive an audio stream from each of the microphones 405, 409, 412 or other audio capture devices, and store the received audio stream in a buffer maintained in a memory or filesystem. The audio buffers 422 may be implemented as a queue, array, linked list, or other suitable data structure.

In some examples, analog audio must first be converted to digital audio using an analog to digital conversion (“ADC”) process. The audio inputs can be buffered using a suitable data format such as the waveform audio file format (“WAV”), a pulse code modulation (“PCM”) format, free lossless audio codec (“FLAC”), raw binary streams, and so on. The audio buffers 422 may store a predefined amount of audio data, corresponding to a specified amount of time (e.g., 10 milliseconds, 100 milliseconds, 1 second, etc.), amount of data (e.g., 1 MB of audio data), or another predefined limit. The multi-microphone audio alignment methods described herein can be applied sequentially, periodically to each batch of buffered data (e.g., 1 per second, 10 per second, etc.) to generate an output audio stream after which the audio buffers 422 are refreshed and the process is repeated.

The audio buffers 422 may be configured as “first-in-first-out” (“FIFO”) queues. Sampled audio input data can be streamed from audio capture devices to the audio buffers 422 which can populate the audio buffers 422 as the data is received. In some examples, the received audio data may include sequencing information (e.g., sequential numbering) to ensure that the data is enqueued in the audio buffers 422 in the correct order.

The audio output generation subsystem 420 includes PLC subsystem 424 that can be used to apply PLC to certain of the audio buffers 422 that are missing audio data due to, for example, network issues, and have sufficient preceding data to extrapolate, interpolate, predict, etc. For example, the PLC subsystem 424 can use a portion of the received audio samples in the audio buffers 422 to generate replacement samples that approximate the missing data using techniques such as waveform extrapolation, parametric modeling, or machine learning-based prediction.

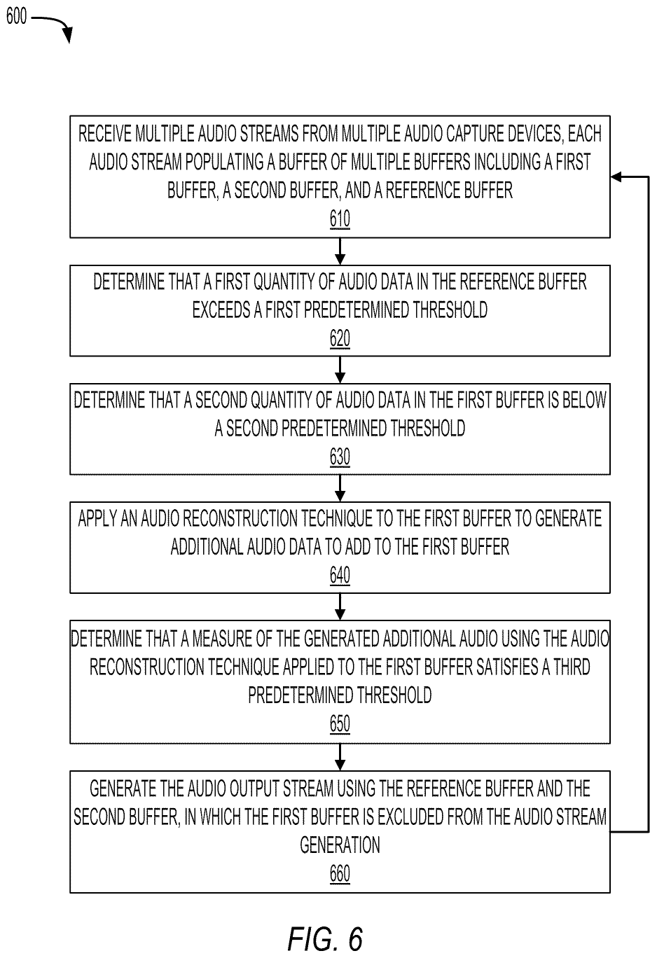

Consider an audio buffer configured to store up to 100 20 millisecond audio frames per processing cycle. For a given example cycle, the audio buffer receives 30 contiguous audio frames from an audio stream, but then, due to a network disruption, 5 audio frames are not received. Then the remaining 65 audio frames are received. PLC can be used to estimate the missing 5 audio frames. However, the effectiveness of PLC may be limited by the size of the gap or the availability of preceding data. For instance, if the audio buffer only receives 1 audio frame followed by a 50 audio frame gap, the output of the PLC subsystem 424 may degrade the overall audio quality if combined with other higher quality sources. Thus, various threshold criteria may be established before a particular audio buffer to which PLC has been applied may be used, as described in more detail with respect to FIG. 6 below.

The PLC subsystem 424 may apply PLC (or other suitable audio reconstruction technique) when the audio data buffered at audio buffers 422 satisfies certain threshold conditions. At the commencement of a session involving audio capture such as a video conference, the PLC subsystem 424 can initially evaluate the status of each buffered audio stream in the audio buffers 422. The audio stream for the primary microphone can populate a designated buffer, referred to as the reference buffer herein. In some examples, the reference buffer can be used as a standalone audio stream for generation of the output audio 432. For instance, since the primary microphone 405 of the integrated video conferencing system 408 does not rely on a network connection in some implementations, it may not experience packet loss.

Initially, while the audio buffers 422 populate, the reference buffer may be used to generate the output audio stream 432. The PLC subsystem 424 can determine that the reference buffer contains a threshold amount of data and that the audio data in the reference buffer satisfies a stability criteria before using the remaining audio buffers for generation of the output audio stream 432. The PLC subsystem 424 can further delay applying audio reconstruction to the remaining buffers until a threshold amount of data has been received by those buffers.

Then, the PLC subsystem 424 can determine that a quantity of audio data in a buffer (e.g., a buffer for the audio capture device 410 or 411) is below a predetermined threshold, indicating that packet loss due to network jitter or other network disruption has occurred or is occurring. The PLC subsystem 424 can then apply an audio reconstruction technique to the buffer to generate additional audio data to add to the buffer. The buffer with generated additional audio data can be used to generate the audio output stream 432 using the reference buffer, the corrected buffer, and any remaining buffers, as described below.

The audio output generation subsystem 420 includes audio selection component 426 that can then select a highest quality portion of the various audio inputs (e.g., the top 2 audio inputs or the top 10% of inputs). The highest quality portion of the various audio inputs can then be aggregated to produce an audio output 432. The aggregation may involve audio smoothing 428, audio mixing 430, as shown, as well as other aggregation operations or audio engineering functions. The audio output 432 can then be output to the video conference provider 402 to be dispatched to the remote client device 435 for playback over audio output device 437.

In some examples, the highest quality portion of the various audio streams may be provided to the video conference provider 402 as separate audio streams instead of or in parallel with smoothing and mixing. For example, the video conference provider 402 may perform mixing, spatial audio rendering, etc. remotely rather than by the integrated video conferencing system 408. This may be done to improve audio quality for the remote client device 435. In another example, the video conference provider 402 may retain the audio streams for archival purposes, such as generating per-speaker transcripts, isolating individual speaker channels for compliance review, and so on.

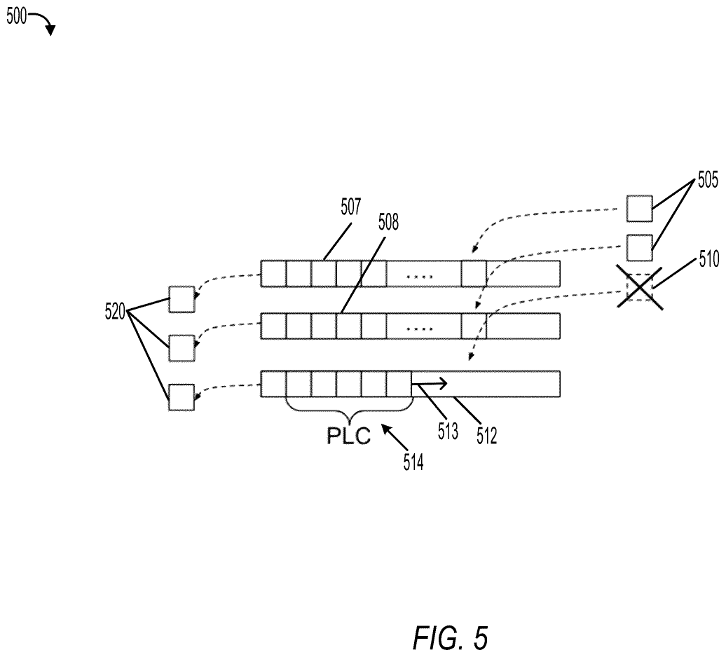

Referring now to FIG. 5, FIG. 5 shows an example of audio buffers 500 that may be used for maintaining audio quality during periods of missing data for multi-microphone systems, according to some aspects of the present disclosure. For example, FIG. 5 depicts examples of the audio buffers 422 shown in FIG. 4 above as may be included in certain implementations of the audio output generation subsystem 420. In particular, FIG. 5 illustrates examples of the PLC subsystem 424 of FIG. 4 maintaining audio quality during periods of missing data for a multi-microphone system, such as an integrated video conferencing system 408, to illustrate certain concepts. FIG. 5 illustrates buffering during packet loss with PLC or other audio reconstruction technique applied.

In the absence of network disruption, the multi-microphone audio buffers 422 store incoming streamed audio frames and supply audio streams for audio synthesis and generation of an output audio stream. For example, the three buffers 507, 508, 512 depicted could correspond to the microphones 405, 409, and 412 of FIG. 4. The topmost buffer may correspond to microphone 405, which is connected to or internal to the integrated video conferencing system 408. In some examples, this audio source can be considered the primary or reference audio source and the topmost buffer may be referred to as the reference buffer 507. In particular, when the microphone 405 is directly connected (e.g., via wire) to the integrated video conferencing system 408, it may be less susceptible to packet loss due to network issues and may therefore be more reliably populated with incoming audio data.

The rate at which audio packets arrive can largely depend on network conditions. The use of audio buffers enables caching of incoming audio packets, each packet including a number of audio frames, which in turn enables regulation of the outflow of aggregated audio data which can mitigate the effects of network jitter and fluctuations while ensuring a more consistent and smooth audio output. In the absence of network disruption (or negligible disruption), the incoming and outgoing rates of audio packets remain balanced, which can keep the buffer sizes stable. For example, the buffer may hold 1 second of data sampled at 10 kHz, or 500 20 millisecond audio frames. Alternatively, the audio buffer may store a certain number (e.g., 1,000 20 millisecond audio frames) or be limited to a certain size (e.g., 1 MB of data). In FIG. 5, the audio frames 505 are shown schematically populating the buffers 507, 508.

When one or more microphones used by audio capture devices connected over a network experience packet loss during transmission or streaming of audio data from the capturing client device to the audio output, their corresponding buffer levels drop. In this example, the third, bottommost buffer 512 corresponds to an audio capture device whose transmission of audio data has ceased. The missing audio frames 510 are shown schematically not populating the buffer 512 using an ‘X.’ Without intervention, no audio data can be consumed from this buffer. In such cases, when a microphone's buffer level is significantly lower than that of other microphones, PLC 514 or other audio reconstruction technique can be applied to fill in the missing data. The arrow 513 shows schematically that the PLC 514 process is populating audio frames to make the buffer 512 contain the same number of audio frames as buffer 507, 508.

As mentioned earlier, PLC or other audio reconstruction techniques are effective for minor packet loss. Moreover, PLC is only effective when there is enough preceding data for the PLC subsystem 424 to accurately predict or interpolate the missing audio. Thus, in cases in which a significant number of packets are lost, relying on PLC can degrade the final audio quality when the audio from the various audio inputs are combined to generate an output audio stream. To mitigate this, the PLC subsystem 424 does not use audio data from microphones experiencing excessive packet loss as measured by a high frequency of PLC application exceeding a predetermined threshold.

As described above, some examples of integrated video conferencing systems may include a built-in microphone or primary microphone. User or other client devices acting as audio capture devices can be communicatively coupled with the integrated video conferencing system, effectively acting as an extended microphone array. These audio capture devices stream audio data to the integrated video conferencing system for final audio synthesis. Audio data from the various connected audio inputs can be smoothed and mixed using DSP components of the audio output generation subsystem 420. For instance, some implementations may select up to two microphones with the highest audio quality to generate the final output audio stream using smoothing and mixing techniques implemented by the audio smoothing component 428 and the audio mixing component 430 described above with respect to FIG. 4. Other techniques or approaches may likewise be used to combine the audio data from the various audio capture devices, such as using machine learning models to predict which audio inputs have the highest quality or using variable numbers of audio inputs.

Referring now to FIG. 6, FIG. 6 shows a flowchart of an example method 600 for maintaining audio quality during periods of missing data for multi-microphone systems, according to some aspects of the present disclosure. The description of the method 600 in FIG. 6 will be made with reference to FIGS. 4-5, however any suitable system according to this disclosure may be used, such as the example systems 100 and 200, shown in FIGS. 1 and 2. It should be appreciated that method 600 provides a particular method for maintaining audio quality during periods of missing data for multi-microphone systems. Other sequences of operations may also be performed according to alternative examples. For example, alternative examples of the present disclosure may perform the steps outlined below in a different order. Moreover, the individual operations illustrated by method 600 may include multiple sub-operations that may be performed in various sequences as appropriate to the individual operation. Furthermore, additional operations may be added or removed depending on the particular applications. Further, the operations described in method 600 may be performed by different devices. For example, the description is given from the perspective of the audio output generation subsystem 420 but other configurations are possible. One of ordinary skill in the art would recognize many variations, modifications, and alternatives.

The method 600 may include block 610. At block 610, a computing system such as the audio output generation subsystem 420 or other component of the integrated video conferencing system 408 of FIG. 4, receives multiple audio streams from multiple audio capture devices, each audio stream populating a buffer of multiple buffers including a first buffer, a second buffer, and a reference buffer. For example, audio capture devices used as extended microphones can transmit their audio packets to an integrated video conferencing system. Each audio packet may include one or more audio frames. An audio frame can represent a fixed-duration segment of encoded audio (e.g., 20 milliseconds of encoded video conference audio captured by one audio capture device). The audio packet is the network-layer container, such as a UDP datagram with an RTP header, that carries one or more audio frames across the network.

At block 620, the computing system determines that a first quantity of audio data in the reference buffer exceeds a first predetermined threshold. For example, the reference audio buffer may correspond to a built-in or primary microphone of the integrated video conferencing system. The first predetermined threshold may correspond to the reference audio buffer having more than a specified amount of buffered data. For example, for a reference buffer sized to contain up to 1,000 20 millisecond audio frames, the first predetermined threshold may be 50, 60, or 70% of the capacity of the reference buffer. This minimum constraint on the reference audio buffer can ensure that there is sufficient high-quality audio available to generate an audio output, even if the audio from all other audio input sources are not available. If the first quantity of audio data in a reference audio buffer is sufficient, the audio output generation subsystem 420 can generate audio output using only the reference audio buffer. This mode of operation may result in low quality audio, however, as the audio from the other audio inputs is not incorporated during this period of time due to insufficient data. This mode of operations can persist long enough to receive enough audio input data by the reference buffer to satisfy the first predetermined threshold. Once the reference buffer level stabilizes above the first predetermined threshold, the process can advance to block 630.

In some examples, even after the first predetermined threshold is satisfied, the computing system can continue to use only the reference buffer (or other specified buffers) when the remaining buffers are empty or lack sufficient data. In this case, the computing system can wait momentarily for incoming packets before proceeding further in this method and use the reference buffer to generate the audio output. For example, for audio buffers sized to contain up to 1,000 20 millisecond audio frames, or 20 second of audio, the computing system may delay 10 seconds to enable the remaining audio buffers besides the reference buffer to populate approximately half-full in the absence of network disruptions.

At block 630, the computing system determines that a second quantity of audio data in the first buffer is below a second predetermined threshold. The built-in primary microphone of the integrated video conferencing system may not experience the same degree of packet loss as other audio capture devices since it does not rely on network transmission. Since the built-in microphone of the integrated video conferencing system can directly capture its own audio, it generally does not experience packet loss. In contrast, the audio capture devices can rely on network transmission, making them susceptible to packet loss due to network jitter. For example, if the first buffer (e.g., the audio buffer corresponding to audio capture device 410) has insufficient data to continue processing (e.g., using the audio buffer for generation of a combined audio output), a PLC method can be applied to compensate for the missing data. Insufficient data may be determined with respect to the second predetermined threshold.

In an example, if the first buffer is sized to contain up to 1,000 20 millisecond audio frames, the second predetermined threshold may be 10, 20, or 30% of the size of the first buffer. The second predetermined threshold may be determined according to the particular application. For example, a video conference with active speaker occasionally changing may warrant a higher threshold while a high-fidelity live music streaming session may use a lower threshold, since replacement frames are more perceptually noticeable in melodic content than in speech.

At block 640, the computing system applies an audio reconstruction technique to the first buffer to generate additional audio data to add to the first buffer. In this case, where the reference audio buffer has sufficient data but the audio in other extended buffers do not have sufficient data, PLC or other audio reconstruction technique can be applied to the other buffers. The audio reconstruction technique may be, for example, PLC. PLC can use methods such as time-domain waveform repetition, linear predictive coding, or deep learning-based synthesis to reconstruct missing audio samples for the first audio buffer. PLC may be applied using PLC methods derived from third-party libraries accessible using a suitable application programming interface (“API”).

In some examples, in the absence of network disruption, the computing system can aggregate and buffer the incoming audio streams, including audio captured using built-in microphones such as the integrated video conferencing system primary microphone. One or more of the buffered audio input streams can be selected, smoothed, and/or mixed to generate an output audio stream. For example, two or more of the highest-quality audio streams can be selected using machine learning techniques for final processing and synthesis. In this case, the computing system can generate the audio output stream using the reference buffer, the first buffer, and the second buffer.

Generation of the audio output can involve accessing data from the audio buffers acting as first-in-first-out (FIFO) queues. In this example, each audio buffer may be populated with audio frames of input audio streams of a particular duration (e.g., 20 milliseconds of audio data) as they are received by the computing system. The audio output generation subsystem 420 may periodically generate audio output by “popping” audio samples from each audio buffer that is first in the queue. In some examples, the sample that is first may be the oldest buffered sample.

At block 650, the computing system determines that a measure of the generated additional audio using the audio reconstruction technique applied to the first buffer satisfies a third predetermined threshold. If relatively small amounts of data are unavailable (e.g., the extended buffers have close to the second predetermined threshold amount of data), PLC can be effectively applied. If relatively large amounts of data are available, PLC is not effective. For example, if PLC is invoked too frequently, indicating substantial packet loss, or if there is insufficient preceding data for PLC to effectively output consonant audio data, the computing system can exclude that audio capture device when selecting audio streams for synthesis into the output audio stream.

For instance, if PLC is requested too frequently (e.g., more frequently than the third predetermined threshold), the computing system may exclude the first audio buffer when selecting audio buffers to generate the output audio. For example, in cases of minor packet loss, PLC effectively covers the gaps, allowing seamless audio playback and inclusion of the first audio buffer. However, where the third predetermined threshold is exceeded and, for example, excessive PLC requests occur, this indicates a high volume of packet loss, reducing the effectiveness of PLC. In such cases, the affected microphone (e.g., the first audio buffer) is excluded from selection for generation of the audio output. In some examples, where all extended audio buffers require excessive PLC, the computing can default to using only the integrated video conferencing system built-in microphone to ensure consistent and high-quality audio output.

The third predetermined threshold may be expressed as time-or data-frequency. For example, third predetermined threshold may be satisfied if PLC is applied more than 10, 20, or 50 times in 1,000 milliseconds. Alternatively, third predetermined threshold may be satisfied if PLC is used to generate more than 20, 30, or 40% of the audio frames in the first buffer. It should be emphasized that, with respect to the first, second, and third predetermined thresholds, the example values are just illustrative examples, and that the values of these predetermined thresholds will vary according to the operational, fidelity, and computational needs and constraints of the particular application.

In some examples, the first predetermined threshold, the second predetermined threshold, and/or the third predetermined threshold may be dynamically determined based on detected network conditions. For example, if high network latency or network jitter is detected by a network monitoring component of the computing system, the third predetermined threshold may be reduced to account for the increased likelihood PLC application. In another example, if low network latency or the absence of network jitter is detected by the network monitoring component of the computing system, the first predetermined threshold may be reduced to allow combination of the audio buffers to proceed with less audio data gathered in the reference buffer; the second predetermined threshold may likewise be reduced to cause PLC to be applied for smaller amounts of missing audio data.

At block 660, the computing system generates the audio output stream using the reference buffer and the second buffer, in which the first buffer is excluded from the audio stream generation. For example, the audio output generation subsystem 420 can select a highest quality portion of the various audio inputs, not including the first buffer. That is, the first buffer may be excluded based on its having exceeded the third predetermined threshold as described in block 640. The highest quality portion of the remaining audio buffers can then be aggregated to produce an audio output 432. The aggregation may involve audio smoothing 428, audio mixing 430, as shown, as well as other aggregation operations or audio engineering functions.

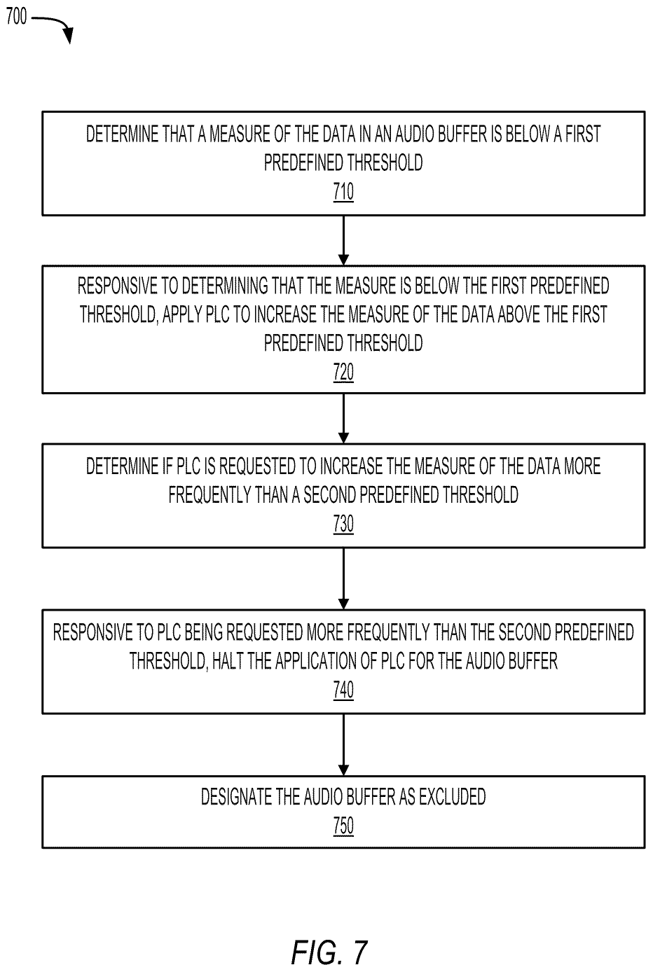

Referring now to FIG. 7, FIG. 7 shows another flowchart of an example method 700 for maintaining audio quality during periods of missing data for multi-microphone systems, according to some aspects of the present disclosure. The method 700 illustrates an example implementation of certain portions of blocks 620-660 of FIG. 6. The description of the method 700 in FIG. 7 will be made with reference to FIGS. 4-5, however any suitable system according to this disclosure may be used, such as the example systems 100 and 200, shown in FIGS. 1 and 2. It should be appreciated that method 700 provides a particular method for maintaining audio quality during periods of missing data for multi-microphone systems. Other sequences of operations may also be performed according to alternative examples. For example, alternative examples of the present disclosure may perform the steps outlined below in a different order. Moreover, the individual operations illustrated by method 700 may include multiple sub-operations that may be performed in various sequences as appropriate to the individual operation. Furthermore, additional operations may be added or removed depending on the particular applications. Further, the operations described in method 700 may be performed by different devices. For example, the description is given from the perspective of the audio output generation subsystem 420 but other configurations are possible. One of ordinary skill in the art would recognize many variations, modifications, and alternatives.

The method 700 may include block 710. At block 710, a computing system such as the audio output generation subsystem 420 or other component of the integrated video conferencing system 408 of FIG. 4, determines that a measure of the data in an audio buffer is below a first predefined threshold. For example, the audio buffer may store audio frames from an audio stream corresponding to an audio capture device. The measure of the data in the audio buffer (e.g., number of audio frames in the audio buffer) may fluctuate as network conditions change from one cycle or batch of audio frames to the next.

At block 720, the computing system, responsive to determining that the measure is below the first predefined threshold, applies PLC to increase the measure of the data above the first predefined threshold. For example, a network disruption may cause the amount of data in the audio buffer to fall below the first predefined threshold during a cycle or batch. The first predefined threshold may be configured or dynamically determined according to the particular application or network conditions. Applying PLC may involve interpolating audio frames based on preceding frames, repeating the last successfully received packet, generating noise to mask gaps caused by lost or delayed packets during transmission, and so on.

At block 730, the computing system determines if PLC is requested to increase the measure of the data more frequently than a second predefined threshold. For example, the second predefined threshold may correspond to PLC being requested for a certain number of consecutive or non-consecutive cycles or batches. In another example, the second predefined threshold may correspond to PLC being applied for more than a certain number of missing audio frames. The second predefined threshold may be configured or dynamically determined according to the particular application or network conditions.

At block 740, the computing system, responsive to PLC being requested more frequently than the second predefined threshold, halts the application of PLC for the audio buffer. PLC may be halted because its application can be inefficacious in the absence of a sufficiently large amount of data. PLC may be halted with the second predefined threshold is exceeded to conserve computational resources.

At block 750, the computing system designates the audio buffer as excluded. Because PLC was halted in block 740, the audio data in the audio buffer may be considered unusable for generation of an output audio stream, generation of a transcript, or other application. In some examples, the computing system can temporarily designate the audio buffer as excluded from downstream applications and revaluate the audio buffer after a certain amount of time or number of cycles or batches have elapsed.

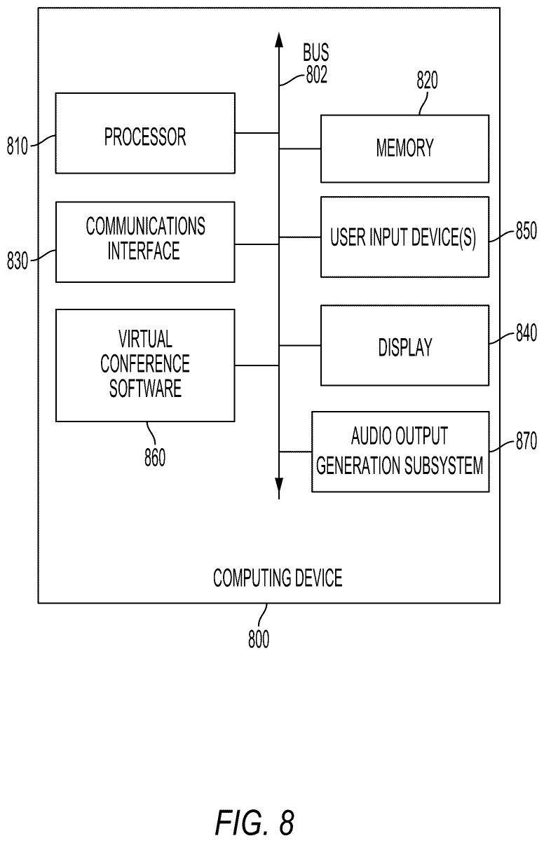

Referring now to FIG. 8, FIG. 8 shows an example computing device 800 suitable for use in example systems or methods for maintaining audio quality during periods of missing data for multi-microphone systems, according to some examples of the present disclosure. The example computing device 800 includes a processor 810 which is in communication with the memory 820 and other components of the computing device 800 using one or more communications buses 802, including the audio output generation subsystem 870. The audio output generation subsystem 870 may be similar to the audio output generation subsystem 420 as described above. The processor 810 is configured to execute processor-executable instructions stored in the memory 820 to perform one or more methods for maintaining audio quality during periods of missing data for multi-microphone systems according to different examples, such as part or all of the example method 600 described above with respect to FIG. 6. The computing device 800, in this example, also includes one or more user input devices 850, such as a keyboard, mouse, touchscreen, microphone, etc., to accept user input. The computing device 800 also includes a display 840 to provide visual output to a user.

In addition, the computing device 800 includes virtual conferencing software 860 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 800 also includes a communications interface 830. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4).

Example 1 is a method, may include: receiving a plurality of audio streams from a plurality of audio capture devices, each audio stream populating a buffer of a plurality of buffers including a first buffer, a second buffer, and a reference buffer; determining that a first quantity of audio data in the reference buffer exceeds a first predetermined threshold; determining that a second quantity of audio data in the first buffer is below a second predetermined threshold; applying an audio reconstruction technique to the first buffer to generate additional audio data to add to the first buffer; and generating an audio output stream using the reference buffer, the first buffer, and the second buffer.

Example 2 is the method as example 1 describes, further may include: determining that a measure of the generated additional audio using the audio reconstruction technique applied to the first buffer satisfies a third predetermined threshold; and generating the audio output stream using the reference buffer and the second buffer, where the first buffer is excluded from the audio stream generation.

Example 3 is the method as either of examples 1 or 2 describe, where determining that the measure of the generated additional audio using the audio reconstruction technique applied to the first buffer satisfies the third predetermined threshold may include: determining that the audio reconstruction technique has been applied to the first buffer more times than the third predetermined threshold within a first time interval.

Example 4 is the method as any of examples 1-3 describe, further may include: determining that a third quantity of audio data in the second buffer is below the second predetermined threshold; applying the audio reconstruction technique to the second buffer to generate additional audio data to add to the second buffer; determining that a measure of the generated additional audio using the audio reconstruction technique applied to the second buffer satisfies the third predetermined threshold; and generating the audio output stream using the reference buffer, where the first buffer and the second buffer are excluded from the audio stream generation.

Example 5 is the method as any of examples 1-4 describe, where the audio reconstruction technique involves packet loss concealment (PLC).

Example 6 is the method as any of examples 1-5 describe, where: the plurality of audio capture devices are communicatively coupled with an integrated video conferencing system; and the integrated video conferencing system is joined to a video conference with one or more remote client device participants hosted by a video conference provider.

Example 7 is the method as any of examples 1-6 describe, where the reference buffer corresponds to a built-in microphone of the integrated video conferencing system.

Example 8 is the method as any of examples 1-7 describe, where generating the audio output stream further may include: identifying the first buffer and the second buffer as buffers corresponding to a measure of the highest quality audio from among the plurality of audio streams, other than the reference buffer.

Example 9 is the method as any of examples 1-8 describe, further may include: prior to determining that the second quantity of audio data in the first buffer is below the second predetermined threshold, determining that the first quantity of audio data in the reference buffer satisfies a stability criteria.

Example 10 is the method as any of examples 1-9 describe, further may include: upon determining that the second quantity of audio data in the first buffer is below the second predetermined threshold, waiting for a predetermined time interval for additional audio data to arrive before applying the audio reconstruction technique to the first buffer.

Example 11 is the method as any of examples 1-10 describe, where the first predetermined threshold and the second predetermined threshold are dynamically determined based on detected network conditions.

Example 12 is a non-transitory computer-readable storage medium storing processor-executable instructions configured to cause one or more processors to: receive a plurality of audio streams from a plurality of audio capture devices, each audio stream populating a buffer of a plurality of buffers including a first buffer, a second buffer, and a reference buffer; determine that a first quantity of audio data in the reference buffer exceeds a first predetermined threshold; determine that a second quantity of audio data in the first buffer is below a second predetermined threshold; apply an audio reconstruction technique to the first buffer to generate additional audio data to add to the first buffer; and generate an audio output stream using the reference buffer, the first buffer, and the second buffer.

Example 13 is the non-transitory computer-readable storage medium as example 12 describes, storing additional processor-executable instructions configured to cause the one or more processors to: determine that a measure of the generated additional audio using the audio reconstruction technique applied to the first buffer satisfies a third predetermined threshold; and generate the audio output stream using the reference buffer and the second buffer, where the first buffer is excluded from the audio stream generation.

Example 14 is the non-transitory computer-readable storage medium as either of examples 12 or 13 describe, where the instruction to determine that the measure of the generated additional audio using the audio reconstruction technique applied to the first buffer satisfies the third predetermined threshold may include:

Example 15 is the non-transitory computer-readable storage medium as any of examples 12-14 describe, where the audio reconstruction technique involves PLC.

Example 16 is the non-transitory computer-readable storage medium as any of examples 12-15 describe, the plurality of audio capture devices are communicatively coupled with an integrated video conferencing system; and the integrated video conferencing system is joined to a video conference with one or more remote client device participants hosted by a video conference provider.

Example 17 is a system may include: one or more non-transitory computer-readable media; and one or more processors communicatively coupled to the one or more non-transitory computer-readable media, the one or more processors configured to execute processor-executable instructions stored in the non-transitory computer-readable media to: receive a plurality of audio streams from a plurality of audio capture devices, each audio stream populating a buffer of a plurality of buffers including a first buffer, a second buffer, and a reference buffer; determine that a first quantity of audio data in the reference buffer exceeds a first predetermined threshold; determine that a second quantity of audio data in the first buffer is below a second predetermined threshold; apply an audio reconstruction technique to the first buffer to generate additional audio data to add to the first buffer; and generate an audio output stream using the reference buffer, the first buffer, and the second buffer.

Example 18 is the system as example 17 describes, storing additional processor-executable instructions configured to cause the one or more processors to: determine that a measure of the generated additional audio using the audio reconstruction technique applied to the first buffer satisfies a third predetermined threshold; and generate the audio output stream using the reference buffer and the second buffer, where the first buffer is excluded from the audio stream generation.

Example 19 is the system as either of examples 17 or 18 describe, where the instruction to determine that the measure of the generated additional audio using the audio reconstruction technique applied to the first buffer satisfies the third predetermined threshold may include:

Example 20 is the system as any of examples 17-19 describe, where the audio reconstruction technique involves PLC.

What is claimed is:

1. A method, comprising:
receiving a plurality of audio streams from a plurality of audio capture devices, each audio stream populating a buffer of a plurality of buffers including a first buffer, a second buffer, and a reference buffer;
determining that a first quantity of audio data in the reference buffer exceeds a first predetermined threshold;
determining that a second quantity of audio data in the first buffer is below a second predetermined threshold;
applying an audio reconstruction technique to the first buffer to generate additional audio data to add to the first buffer; and
generating an audio output stream using the reference buffer, the first buffer, and the second buffer.

2. The method of claim 1, further comprising:
determining that a measure of the generated additional audio using the audio reconstruction technique applied to the first buffer satisfies a third predetermined threshold; and
generating the audio output stream using the reference buffer and the second buffer, wherein the first buffer is excluded from the audio stream generation.

3. The method of claim 2, wherein determining that the measure of the generated additional audio using the audio reconstruction technique applied to the first buffer satisfies the third predetermined threshold comprises:
determining that the audio reconstruction technique has been applied to the first buffer more times than the third predetermined threshold within a first time interval.

4. The method of claim 2, further comprising:
determining that a third quantity of audio data in the second buffer is below the second predetermined threshold;
applying the audio reconstruction technique to the second buffer to generate additional audio data to add to the second buffer;
determining that a measure of the generated additional audio using the audio reconstruction technique applied to the second buffer satisfies the third predetermined threshold; and
generating the audio output stream using the reference buffer, wherein the first buffer and the second buffer are excluded from the audio stream generation.

5. The method of claim 1, wherein the audio reconstruction technique involves packet loss concealment (PLC).

6. The method of claim 1, wherein:
the plurality of audio capture devices are communicatively coupled with an integrated video conferencing system; and
the integrated video conferencing system is joined to a video conference with one or more remote client device participants hosted by a video conference provider.

7. The method of claim 6, wherein the reference buffer corresponds to a built-in microphone of the integrated video conferencing system.

8. The method of claim 1, wherein generating the audio output stream further comprises:
identifying the first buffer and the second buffer as buffers corresponding to a measure of the highest quality audio from among the plurality of audio streams, other than the reference buffer.

9. The method of claim 1, further comprising:
prior to determining that the second quantity of audio data in the first buffer is below the second predetermined threshold, determining that the first quantity of audio data in the reference buffer satisfies a stability criteria.

10. The method of claim 1, further comprising:
upon determining that the second quantity of audio data in the first buffer is below the second predetermined threshold, waiting for a predetermined time interval for additional audio data to arrive before applying the audio reconstruction technique to the first buffer.

11. The method of claim 1, wherein the first predetermined threshold and the second predetermined threshold are dynamically determined based on detected network conditions.

12. A non-transitory computer-readable storage medium storing processor-executable instructions configured to cause one or more processors to:
receive a plurality of audio streams from a plurality of audio capture devices, each audio stream populating a buffer of a plurality of buffers including a first buffer, a second buffer, and a reference buffer;
determine that a first quantity of audio data in the reference buffer exceeds a first predetermined threshold;
determine that a second quantity of audio data in the first buffer is below a second predetermined threshold;
apply an audio reconstruction technique to the first buffer to generate additional audio data to add to the first buffer; and
generate an audio output stream using the reference buffer, the first buffer, and the second buffer.

13. The non-transitory computer-readable storage medium of claim 12, storing additional processor-executable instructions configured to cause the one or more processors to:
determine that a measure of the generated additional audio using the audio reconstruction technique applied to the first buffer satisfies a third predetermined threshold; and
generate the audio output stream using the reference buffer and the second buffer, wherein the first buffer is excluded from the audio stream generation.

14. The non-transitory computer-readable storage medium of claim 13, wherein the instruction to determine that the measure of the generated additional audio using the audio reconstruction technique applied to the first buffer satisfies the third predetermined threshold comprises:
determining that the audio reconstruction technique has been applied to the first buffer more times than the third predetermined threshold within a first time interval.

15. The non-transitory computer-readable storage medium of claim 12, wherein the audio reconstruction technique involves PLC.

16. The non-transitory computer-readable storage medium of claim 12,
the plurality of audio capture devices are communicatively coupled with an integrated video conferencing system; and
the integrated video conferencing system is joined to a video conference with one or more remote client device participants hosted by a video conference provider.

17. A system comprising:
one or more non-transitory computer-readable media; and
one or more processors communicatively coupled to the one or more non-transitory computer-readable media, the one or more processors configured to execute processor-executable instructions stored in the non-transitory computer-readable media to:
receive a plurality of audio streams from a plurality of audio capture devices, each audio stream populating a buffer of a plurality of buffers including a first buffer, a second buffer, and a reference buffer;
determine that a first quantity of audio data in the reference buffer exceeds a first predetermined threshold;
determine that a second quantity of audio data in the first buffer is below a second predetermined threshold;
apply an audio reconstruction technique to the first buffer to generate additional audio data to add to the first buffer; and
generate an audio output stream using the reference buffer, the first buffer, and the second buffer.

18. The system of claim 17, storing additional processor-executable instructions configured to cause the one or more processors to:
determine that a measure of the generated additional audio using the audio reconstruction technique applied to the first buffer satisfies a third predetermined threshold; and
generate the audio output stream using the reference buffer and the second buffer, wherein the first buffer is excluded from the audio stream generation.

19. The system of claim 18, wherein the instruction to determine that the measure of the generated additional audio using the audio reconstruction technique applied to the first buffer satisfies the third predetermined threshold comprises:
determining that the audio reconstruction technique has been applied to the first buffer more times than the third predetermined threshold within a first time interval.

20. The system of claim 17, wherein the audio reconstruction technique involves PLC.
